(19) United States
(12) Patent Application Publication
(10) Pub. No.: US 2025/0307096 A1
(43) Pub. Date: Oct. 2, 2025

(54) SERIALIZING DATA USING HYBRID TRANSMISSION MODES WITHIN A MEMORY SYSTEM

(71) Applicant: Micron Technology, Inc., Boise, ID (US)

(72) Inventors: Andrea Sorrentino, München (DE); Marcos Alvarez Gonzalez, München (DE); Luiza Souza Correa, München (DE); Wolfgang Anton Spirkl, Germering (DE); Paritosh Piyush Sahu, München, (DE); Kevin Gajera, Munich (DE); Natalija Jovanovic, München (DE)

(21) Appl. No.: 19/088,752

(22) Filed: Mar. 24, 2025

Related U.S. Application Data
(60) Provisional application No. 63/571,328, filed on Mar. 28, 2024.

(51) Int. Cl. G06F 11/22; G06F 13/16; G06F 13/42

(52) U.S. Cl. CPC G06F 11/2273; G06F 11/2221; G06F 13/1668; G06F 13/4282

(57) ABSTRACT

Methods, systems, and devices for serializing data using hybrid transmission modes within a memory system are described. A memory system may include conversion circuitry for converting symbols of a first modulation scheme into symbols of a second modulation scheme. During an operating mode, the memory system may transfer data via a data path and via an interface in accordance with the first modulation scheme at a first data rate. During a test mode, the memory system may transfer data via the data path in accordance with the first modulation scheme at the first data rate, and may convert the data to a second modulation scheme for transfer via the interface at a second data rate. To return to the operating mode, the memory system may be reset or may receive a dedicated signal to enter the operating mode.

### CROSS REFERENCE

The present Application for Patent claims priority to U.S. Patent Application No. 63/571,328 by Sorrentino et al., entitled “SERIALIZING DATA USING HYBRID TRANSMISSION MODES WITHIN A MEMORY SYSTEM,” filed Mar. 28, 2024, which is assigned to the assignee hereof, and which is expressly incorporated by reference in its entirety herein.

### TECHNICAL FIELD

The following relates to one or more systems for memory, including serializing data using hybrid transmission modes within a memory system.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports serializing data using hybrid transmission modes within a memory system in accordance with examples as disclosed herein.

FIGS. 2A and 2B show examples of timing diagrams that support serializing data using hybrid transmission modes within a memory system in accordance with examples as disclosed herein.

FIG. 3 shows an example of a circuit diagram that supports serializing data using hybrid transmission modes within a memory system in accordance with examples as disclosed herein.

FIG. 4 shows a block diagram of a memory system that supports serializing data using hybrid transmission modes within a memory system in accordance with examples as disclosed herein.

FIG. 5 shows a flowchart illustrating a method or methods that support serializing data using hybrid transmission modes within a memory system in accordance with examples as disclosed herein.

### DETAILED DESCRIPTION

A memory system may include, among other aspects, a data path and an interface. The data path may correspond to one or more internal data paths within a memory device (e.g., between memory blocks) or across multiple memory devices, and the interface may correspond to one or more channels between the memory system and an external system or device (e.g., a host system). The data path, in some systems, may support different data rates (e.g., speeds, rates for data transfer) than the interface, which may cause one or more operations, such as test operations, to finish prematurely if the data path or the interface fails. Therefore, some systems may be unable to detect a maximum supported data rate for both the interface and the data path, as operating (e.g., testing) may be limited by a lowest supported data rate of two data rates, each data rate respectively supported by the interface, or the data path, or both. Thus, techniques for testing whether a data path, an interface, or both, may run at a higher speed without failing the other may be beneficial.

As described herein, a memory system may support decreasing a speed at which an interface runs by serializing data using hybrid transmission modes involving multiple modulation schemes. In one or more operating modes (e.g., operation modes) of the memory system, a data path and an interface may execute at a same speed or at least a similar speed with a corresponding data rate and modulation scheme. In one or more modes (e.g., test modes) supported by the memory system as described herein, the data path may convey data according to a first speed, such as a maximum speed (e.g., full speed), by using a first modulation scheme, such as a phase amplitude modulation (PAM) scheme, while the interface may convey data according to a second speed (e.g., a slower speed than the first speed) by using a second modulation scheme, such as a non-return-to-zero (NRZ) scheme, or vice versa. During a read operation, a data path may convey bits of data over two parallel lines (e.g., even and odd) that may be encoded in accordance with a PAM3 scheme, where PAM3 signaling may involve transmitting one of three levels to indicate a symbol corresponding to a pair of bits transmitted in parallel over both lines.

The memory system may adjust (e.g., slow) a data rate over the interface according to the test mode by converting to a different modulation scheme. For example, the memory system may include conversion circuitry within a serializer that may convert PAM3 symbols into NRZ bits before serializing data for transmission. The conversion may serialize each symbol into two bits, so that each bit is transferred via both parallel lines before the memory system transmits one of two corresponding levels. Converting to using NRZ may thus halve a data rate at the interface (e.g., after serialization) as NRZ may enable transmission of a first half of the data during a duration in which PAM3 encoding would allow transmission of the full data. In some examples, to obtain a second half of the data, the memory system may receive one or more commands to output temporarily saved data, such as from a previous read operation. Due to the switch to NRZ, a data eye diagram corresponding to each bit that is transmitted may have twice a height of PAM3 signaling, which may improve an accuracy of strobing by a receiver (e.g., the host system) of the data. Additionally, or alternatively, the test mode may support testing of the data path at one or more data rates that may not be supported by the interface, or vice versa. In some examples, the test mode may be set by a controller or via some other signaling from a host system or an external device, such as by a mode register set (MRS) command. To return to the operating mode, the memory system may be reset or may receive another dedicated signal to enter the operating mode.

In addition to applicability in memory systems as described herein, techniques for serializing data using hybrid transmission modes within a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by providing for independent testing of a data path and an interface within a device, which may improve testing accuracy and reliability, providing for improved device performance, reduced latency, and higher supported data rates.

In addition to applicability in memory systems described herein, techniques for serializing data using hybrid transmission modes within a memory system may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by providing more accurate testing of general device performance to improve device reliability, which may improve a reliability of security and authentication protocols implemented at a device while incurring lower latency costs (e.g., by implementing it at hardware level) in related communications, among other benefits.

Features of the disclosure are illustrated and described in the context of systems and architectures. Features of the disclosure are further illustrated and described in the context of timing diagrams, serializing circuits, block diagrams, and flowcharts.

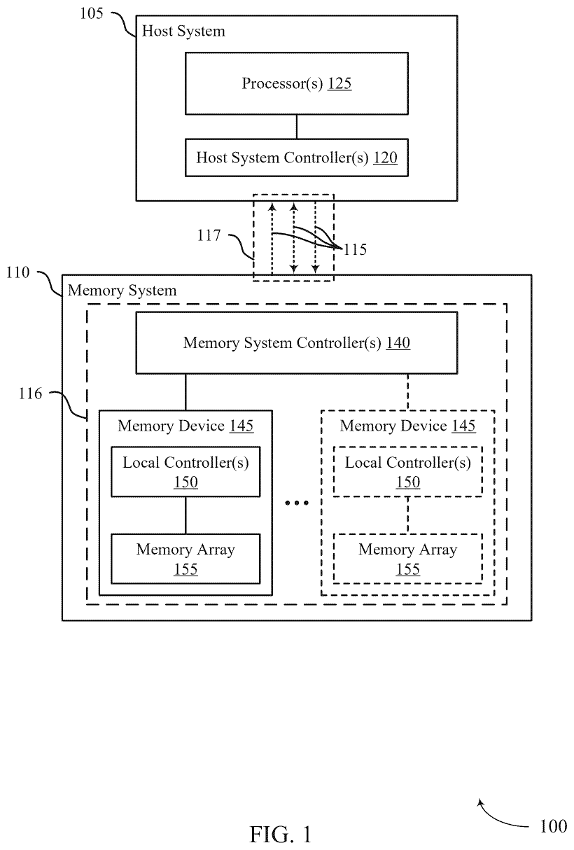

FIG. 1 illustrates an example of a system 100 that supports serializing data using hybrid transmission modes within a memory system in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

Signals communicated over the channels 115 may be modulated using various modulation schemes or combinations thereof. A symbol of a binary-symbol (e.g., binary-level) modulation scheme may be operable to represent one bit of data (e.g., a symbol may represent a logic 1 or a logic 0), and may be an example of an M-ary modulation scheme where M is equal to two. Examples of binary-symbol modulation schemes include NRZ, unipolar encoding, bipolar encoding, Manchester encoding, PAM having two symbols (e.g., PAM2), and others. A symbol of a multi-symbol modulation scheme may be operable to represent more than one bit of data (e.g., a symbol may represent a logic 00, a logic 01, a logic 10, or a logic 11), and may be an example of an M-ary modulation scheme where M is greater than or equal to three. For example, a multi-symbol signal may be modulated using a modulation scheme that includes at least three levels to encode more than one bit of information. Multi-symbol modulation schemes and symbols may be referred to as non-binary, multi-bit, or higher-order modulation schemes and symbols. Examples of multi-symbol modulation schemes include PAM3, PAM4, PAM8, and so on, quadrature amplitude modulation (QAM), quadrature phase shift keying (QPSK), and others.

Signaling of the memory system 110 and the host system 105 may also support usage of one or more error correction codes (ECC) and cyclic redundancy check (CRC) bits. CRC bits may be included at the end of a data transmission to protect data bits and may be used to detect bit failures. In some cases, CRC data link protection may be supported for both read and write operations, where data link protection may refer to signaling between the host system 105 and the memory system 110. CRC bits may be computed for each burst transfer on data and may be associated with metadata. During a read operation, the memory system 110 may calculate and send CRC bits on a data signal (e.g., DQ signal) to the host system controller 120 which may calculate the CRC bits on the received data and compare the result to validate the transfer. During writes, the host system 105 may calculate and send CRC bits to the memory system 110 and, together with the write data, the memory system 110 may calculate the CRC bits on the received data and compares it with the received CRC bits to determine if there are one or more errors present due to the transfer. In case of a mismatch, the memory system 110 may return to the host an error flag. In some cases, such CRC operations may be supported by a parallel transfer operation, where one or more CRC bits may be transmitted concurrently on a first line (e.g., even line) and a second line (e.g., odd line), which may each include one or more respective data paths and channels.

In some examples, the memory system 110 may include a data path 116 and an interface 117. For example, the data path 116 may include an internal data path within or across one or more memory devices 145 (e.g., between blocks of one or more memory arrays 155, between one or more memory devices 145 and the memory system controller 140, or any combination thereof). The interface 117 may correspond to the one or more channels 115 between the memory system 110 and the host system 105 (or one or more other channels between the memory system 110 and one or more other external devices). The data path 116 and the interface 117 may support one or more data rates (e.g., speeds) for both SDR and DDR signaling. In some cases, however, different data rates between the data path 116 and interface 117 may result in a failure of one or more operations. For example, in a test operation, the memory system 110 may exchange signaling via the interface 117 with the host system 105 for a write operation, a read operation, or both, involving accessing memory arrays 155 of one or more memory device 145 via the data path 116. The host system 105 may increase a data rate for operations to test a maximum data rate of the interface 117 and the data path 116. However, if the interface 117 supports a lower data rate than the data path 116, the interface 117 may fail (e.g., at a respective maximum data rate) before the data path 116 reaches a maximum data rate for the data path. Thus, the host system 105 and the memory system 110 may be unable to detect a maximum supported data rate for both the interface 117 and the data path 116 concurrently.

As described herein, a memory system 110 may support decreasing a speed at which an interface runs by serializing data using hybrid transmission modes involving multiple modulation schemes. For example, the memory system may adjust a data rate over the interface 117 according to a test mode by converting a modulation scheme. In some cases, the memory system may include conversion circuitry within a serializer that may convert PAM3 symbols (e.g., transferred via the data path 116) into NRZ bits before serializing data for transmission. The conversion may serialize each symbol into two bits, so that each bit is transferred via parallel lines before the memory system 110 transmits one of two corresponding levels to the host system 105. Converting to using NRZ may thus halve a data rate at the interface (e.g., after serialization) as NRZ may enable transmission of a first half of the data during a duration in which PAM3 encoding would allow transmission of the full data. To obtain a second half of the data, the memory system may receive one or more commands to output temporarily saved data from a previous read operation. Due to the switch to NRZ, a data eye diagram corresponding to each bit that is transmitted may have twice a height of PAM3 signaling, which may improve an accuracy of strobing by a receiver (e.g., the host system 105) of the data. Additionally, or alternatively, the test mode may support testing of the data path at one or more data rates that may not be supported by the interface, or vice versa. In some examples, the test mode may be set by a controller or via some other signaling from a host system 105 or an external device (e.g., by an MRS command). To return to the operating mode, the memory system 110 may be reset or may receive another dedicated signal to enter the operating mode.

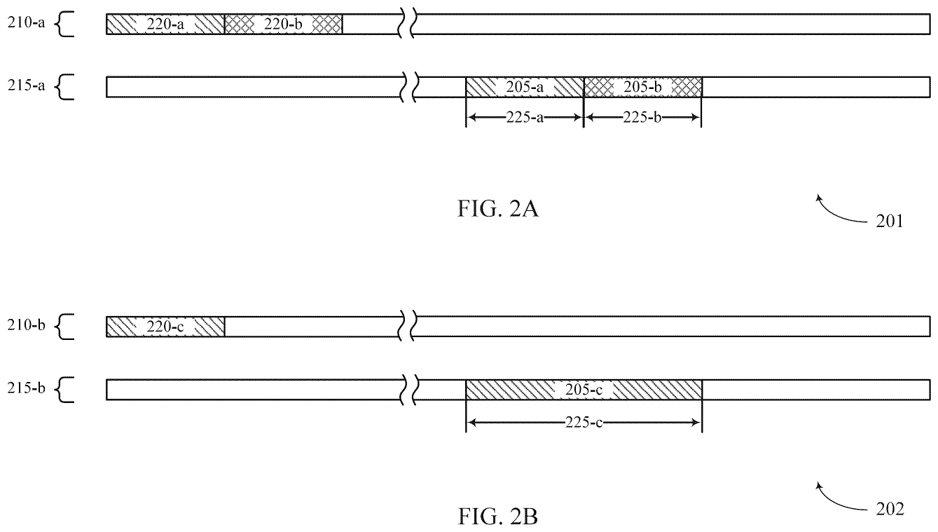

FIGS. 2A and 2B shows examples of timing diagrams 201 and 202 that support serializing data using hybrid transmission modes within a memory system in accordance with examples as disclosed herein. One or more aspects of the timing diagrams 201 and 202 may be implemented by one or more aspects of the system 100. For example, the timing diagram 201 may illustrate timing for a PAM3 mode for a PAM3 scheme, such as a read PAM3 mode, at the memory system 110 while the timing diagram 202 may illustrate timing for an NRZ mode for an NRZ scheme, such as a read NRZ mode, at the memory system 110 for data 205. In some examples, the data 205 may be transferred (e.g., sent via a conductor, read, written) according to (e.g., based on, in response to) commands received via command lanes 210 (e.g., a command address (CA) channel) at a command pin of the memory system 110, while the data 205 may include one or more bits for communication via one or more data lanes 215 (e.g., DQ lane) at a data pin (e.g., DQ pin) of the memory system 110. For example, FIGS. 2A and 2B may illustrate a command lane 210-a and a command lane 210-b, respectively, as well as a data lane 215-a and a data lane 215-b, respectively. Data lanes 215 may correspond to one or both of the data path 116 of the memory system 110 or a DQ channel (e.g., DQ1, DQ2, up to DQE, or any other DQ channel), such as of the channels 115 of the interface 117.

In the example of FIG. 2A, the memory system 110 may receive one or more commands for PAM3 reads. For example, the memory system 110 may receive, via the command lane 210-a, a command 220-a to read data 205-a and a command 220-b to read data 205-b from one or more memory cells of an array of one or more blocks of memory cells of the memory system 110. In some cases, the commands 220-a and 220-b and subsequent read operations may be back-to-back for different banks of memory cells (e.g., gapless PAM3 back-to-back reads with tCCD=2, where tCCD may indicate cycles between groups of successive commands). The memory system 110 may perform (e.g., via the memory system controller 140 or one or more local controllers 150) subsequent read operations to read the data 205-a and the data 205-b following reception of the read commands 220, and may transfer the data 205-a and 205-b according to PAM3 encoding (e.g., after encoding using one or more encoders) via the data lane 215-a (e.g., via a data path 116 or the interface 117, or both).

In the example of FIG. 2B, the memory system 110 may similarly receive commands for an NRZ read. For example, the memory system 110 may receive, via the command lane 210-b, a command 220-c to read data 205-c from one or more memory cells of an array of one or more blocks of memory cells of the memory system 110. In some cases, an NRZ mode may include a single NRZ read command for a single NRZ read with read CRC (RDCRC) with command and address (CA) parity enabled and on-die termination (ODT) disabled (e.g., may include one or more CRC even bits for even bits of data and CRC odd bits for odd bits of data, among other data bits). After receiving the read command 220-c, the memory system 110 may transfer the data 205-c according to NRZ encoding via the data lane 215-b (e.g., via a data path 116 or the interface 117 or both).

The read PAM3 mode as illustrated in FIG. 2A may allow transfer of a larger quantity of data during a same duration compared to the read NRZ mode. For example, if the data 205-a includes a quantity of N bits, the read PAM3 mode may encode the data 205-a into a quantity of M symbols for transmission, where each symbol may correspond to one of three amplitude modulation levels (e.g., −1, 0, and +1). In some cases, an amplitude modulation level may represent a voltage level (e.g., of a corresponding amplitude) for a signal for transmission that may correspond to one or more bits of a modulation scheme. The read PAM3 mode may allow the memory system 110 to transfer the data 205-a within a duration 225-a (e.g., Y/2 clock cycles, a time period). The next read operation of the data 205-b, which may include the same quantity of N bits as the data 205-a, may occupy a same duration of time, represented by the duration 225-b.

The read NRZ mode, however, may encode the quantity of N bits into N symbols for transmission corresponding to one of two amplitude modulation levels (e.g., −1 and +1). Thus, although the data 205-c may include a same quantity of N bits as the data 205-a and the data 205-b, a time for transferring the data 205-c may span a duration 225-c (e.g., Y clock cycles) that is greater than (e.g., twice as long as) the duration 225-a and the duration 225-b (e.g., N=2 M). Thus, because the duration 225-c for transmitting N bits of data using the NRZ mode may be the same as a total duration including both the duration 225-a and the duration 225-b for transmitting N bits of data using the PAM3 mode, the read PAM3 mode may support transfer of twice as much data as compared to the read NRZ mode, in some examples. This may result in a data rate for the read PAM3 mode that is twice as fast as that of the read NRZ mode. The NRZ mode as illustrated in FIG. 2B, however, may be associated with a larger data eye height for transmissions. For example, by utilizing two symbols and two corresponding amplitude modulation levels (e.g., +1 and −1) for data transmission, the NRZ mode may have a data height that is twice that of PAM3 mode, which has three amplitude modulation levels (e.g., +1, 0, and −1). The increased data eye height may improve accuracy of the data transmission and reception, as the data may be decoded more reliably as compared with data transmitted with a smaller data eye height.

In some examples, the memory system 110 may implement both PAM3 mode and NRZ mode to decrease a speed at which the interface 117 runs and to allow the data path 116 to run at a faster speed than the interface. For example, the memory system 110 may transfer data over the data path 116 using PAM3 encoding to allow a higher data rate, and the memory system 110 may convert the data to NRZ encoding before transmission to the host system 105. This may allow the memory system 110 to transmit via the interface 117 at a lower data rate (e.g., transmitting one bit at a time instead of two) than the data path 116, which may enable testing operations to determine a maximum speed of the data path without causing failure on the interface 117, among other operations. Further, doing so may double a height of a data eye for each transmitted symbol, which may allow more accurate strobing of data at the host system 105. Although FIGS. 2A and 2B illustrate PAM3 and NRZ read modes, it is to be understood that the memory system 110 may support some other combination of two or more encoding modes including two or more amplitude modulation levels and corresponding data rates. Additionally, or alternatively, the memory system 110 may support similar operations for one or more write operations, where the commands 220 may represent write commands for one or more PAM3 mode writes and NRZ mode writes.

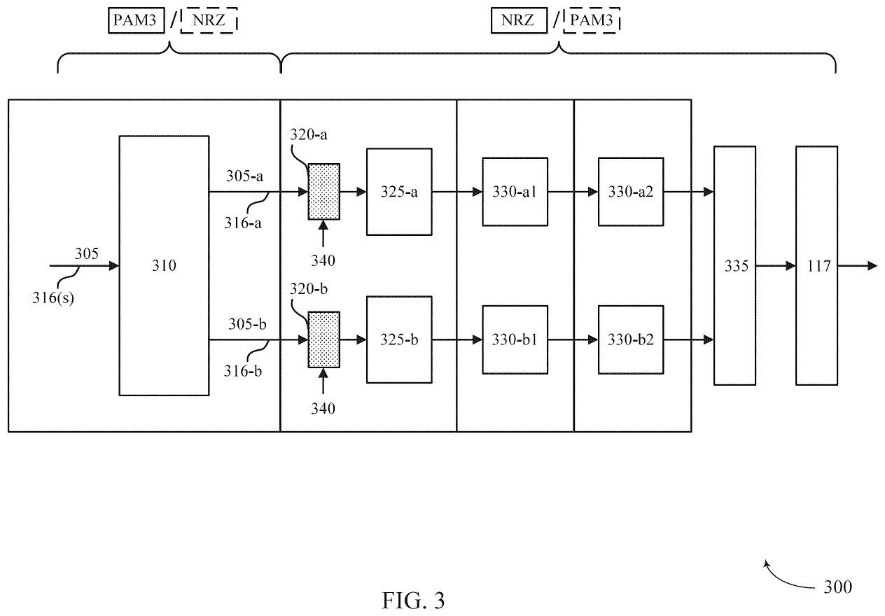

FIG. 3 shows an example of a circuit diagram 300 that supports serializing data using hybrid transmission modes within a memory system in accordance with examples as disclosed herein. One or more aspects of the circuit diagram 300 may be implemented by one or more aspects of the system 100, the timing diagram 201, or the timing diagram 202, as described with reference to FIGS. 1, 2A, and 2B. For example, the circuit diagram 300 may illustrate one or more circuits (e.g., circuitry) of the memory system 110 supporting conversion between different modulation modes to adjust a data rate at the interface 117 or the data path 116, or both.

The memory system 110 may include one or more data paths 316 configured to convey data 305. For example, the memory system 110 may include at least two data paths including a data path 316-a and a 316-b that may be configured to transfer data from a memory array, such as data 305-a and data 305-b, in parallel. The data paths 316 may be included in or otherwise coupled with the data path 116 described with reference to FIG. 1. In some examples, the memory system 110 may include a FIFO circuit 310 that may be coupled with the data paths 316-a and 316-b. In some examples, the FIFO circuit 310 may have a depth, X, that corresponds to a quantity of reads (e.g., eight reads or some other quantity) or writes for which the FIFO may store corresponding data. The FIFO circuit 310 may be coupled with an input of the data paths 316-a and 316-b, and may be coupled with an output of one or more additional data paths 316 (e.g., parallel data paths corresponding to the data paths 316-a and 316-b or a single data path for carrying data 305 corresponding to the data 305-a and the data 305-b). Although two data paths may be shown, it is to be understood that the data 305 may be split into any quantity of subsets and transferred within the memory system 110 via any quantity of data paths 316.

The FIFO circuit 310 and data paths 316 may be configured to convey data in accordance with a first quantity of amplitude modulation levels. For example, the FIFO circuit 310 and the data paths may be running in PAM3 mode and may transfer data (e.g., of a read operation) according to PAM3 encoding. For PAM3 encoding, the data 305 may be encoded into a quantity of symbols for transmission, where each symbol may correspond to a pair of bits of the data 305 including a most significant bit (MSB), and a least significant bit (LSB). The LSB (e.g., of the data 305-a) and the MSB (e.g., of the data 305-b) may be transmitted in parallel via the data paths 316-a and 316-b, respectively. Accordingly, the symbol may correspond to one of at least three levels for transmission (e.g., via the interface 117) that may correspond to or indicate the MSB and the LSB (e.g., having combined value of 0, 1, 2, for example). In some cases, an output pointer of the FIFO circuit 310 may change over half as many cycles in PAM3 mode compared to NRZ mode (e.g., every Y clock cycles in NRZ mode and every Y/2 clock cycles in PAM3 mode).

The memory system 110 may also include conversion circuitry with one or more components configured to convert the first quantity of amplitude modulation levels for the data 305 to a second quantity of amplitude modulation levels (e.g., that is less than the first quantity, that is more than the first quantity). For example, a converter 320-a may be coupled with the data path 316-a and a converter 320-b may be coupled with the data path 316-b. The converters 320-a and 320-b may convert the three modulation levels of the PAM3 encoded data 305-a and 305-b into two modulation levels for NRZ data. The converters 320 may be located at an edge of the memory system 110 between the interface 117 and the data path 116, and may be separate or part of a same conversion circuitry package. For example, although two converters 320 are illustrated in FIG. 3, it is to be understood that the memory system 110 may include any quantity of one or more converters 320.

The memory system 110 (e.g., a DRAM system) may include serializer circuitry (e.g., a parallel to serial circuit (serializer) which may support PAM3 or NRZ mode) coupled with the conversion circuitry and configured to serialize the data 305 for transmission. For example, the converter 320-a may be coupled with an input of a latch 325-a, which may be coupled with one or more serializers 330, including serializers 330-a1 and 330-a2. The converter 320-b may similarly be coupled with a latch 325-b, a serializer 330-b1, and a serializer 330-b2. After converting the data to the NRZ mode (e.g., or some other encoding mode), memory system 110 may serialize the data 305-a and the data 305-b using the serializers 330-a1 and 330-b1 to convert packets of bits into multiple serial subsets of bits, and using the serializers 330-a2 and 330-b2 to convert the subsets into individual serial bits transmitted via two parallel lines. The serializers 330 may be coupled with the interface 117 directly, or indirectly via an off-chip driver (OCD) 335 (coupling the converters 320 with the interface 117). The memory system 110 may thus be configured to transmit the data 305-a and the data 305-b as a serial stream of data via the interface 117. It is to be understood that the serializer circuitry may include any combination and quantity of components and other circuitry configured to serialize data (e.g., PAM3 or NRZ encoded data). For example, the serializer circuitry may include more or less serializers 330-a than illustrated, among other examples.

In some examples, the memory system 110 may be configured to transfer the data according to one or more modulation modes based on a test mode for the memory system 110. For example, the memory system 110 may include one or more pins 340 configured to receive signaling (e.g., from a host system) indicating whether the test mode (e.g., a test of the data path 116, a test of the interface 117, or both at one or more data rates) is enabled for the memory system 110, where the pin 340 may be coupled with the converters 320-a and 320-b via one or more wires or other conductors. In some examples, the pin 340 may receive a single value applied to both converters 320-a and 320-b, or the pin 340 may receive a multi-bit indication or some other set of multiple values, including a different value for each of the converters 320-a and 320-b. The signal conveyed to the converters 320-a and 320-b may activate or deactivate the converters 320-a and 320-b. For example, if the signal indicates a test mode, the signal may activate the converters 320-a and 320-b, such that the converters 320-a and 320-b convert an encoding scheme of the data before transferring the data to the serializer circuitry. If the signal indicates that a test mode is not enabled, the converters 320-a and 320-b may be deactivated, such that the data may pass through or around the converters 320-a and 320-b, and the encoding scheme of the data may not be modified. That is, both the data path 316 and the interface 117 may transfer the data using a same encoding scheme.

After receiving an indication of the test mode via the pin 340, the converters 320 may convert the data 305-a and 305-b, and the interface 117 may transmit data 305-a and 305-b, in accordance with the second quantity of levels (e.g., operating in NRZ mode). For example, a PAM3 symbol of [0, 1] transmitted as a ‘1’ on the data path 316-a and a ‘0’ on the data path 316-b simultaneously may be converted to NRZ so that a ‘0’ is transmitted simultaneously over both paths within the serializer circuitry, and a ‘1’ is transmitted after the ‘0’s, where each bit may be indicated by an NRZ modulation level at the interface 117 (e.g., instead of indicating both bits with a PAM3 modulation level).

Additionally, or alternatively, the memory system 110 may receive an indication via the pin 340 of a second mode, such as an operational mode, for the memory system. In such a case, the converters 320 may act as pass-through circuitry and the memory system 110 may transfer data (e.g., the data 305, additional or second data 305) from one or more memory arrays via the data paths 316, as well as serialize and transmit the data via the interface 117 in accordance with the first quantity of amplitude modulation levels (e.g., operating in PAM3 mode). In some cases, data may be transferred via the data paths 316 in a first time period in the test mode and via the interface 117 in a second time period that may be longer than the first time period due to the second quantity of modulation levels being less than the first quantity of modulation levels. The test mode may be set by a controller (e.g., in addition to or in place of the pin 340) or via other signaling from the host system 105 or an external device (e.g., by an MRS command). Additionally, or alternatively, the memory system 110 may be reset to enter the operating mode.

The memory system 110 may perform one or more read operations using the circuitry illustrated in FIG. 3. For example, after receiving one or more read commands from the host system 105 to read the data 305, the memory system 110 may read the data from one or more memory arrays as well as convert (or not convert) and transmit the data to the host system 105. In some examples, the memory system 110 may receive a quantity of read commands (e.g., eight read commands, or some other quantity). The quantity of read commands may correspond to a parameter, such as the depth, X, of the FIFO circuit 310. The memory system 110 may read and store the data 305 in the FIFO circuit 310. During the test mode, as the data paths 316-a and 316-b may be run at full speed (e.g., back-to-back with tCCD=2) and with the serializers 330 running in NRZ mode, half of the data 305 may be transmitted outside of the memory system 110 during a time period. For example, as NRZ may involve twice as long of a duration to indicate the same information as PAM3 encoding (as described with reference to FIGS. 2A and 2B), a first half of the information may be transmitted before a next read command is received. Thus, the first X read commands may trigger the memory system 110 to output one half of the requested data by the time that the X commands finish, and a remainder of the data may be remain stored in the FIFO circuit 310. In some examples, the host system 105 may issue X read train commands (e.g., RDTR commands) which may drive the remaining data from the FIFO circuit 310 to the DQ pins to complete the reads in NRZ mode (e.g., will give out the next half of the read command data).

Additionally, or alternatively, the memory system 110 may convert received data to a different modulation scheme. For example, the memory system 110 may receive, via the interface 117, a second data in accordance with the second quantity of amplitude modulation levels (e.g., in NRZ mode) based on the test mode. The memory system 110 may convert the second data to the first quantity of amplitude modulation levels (e.g., in PAM3 mode) using the converters 320, and may transfer, to one or more memory arrays and via the data paths 316, the second data in accordance with the first quantity of amplitude modulation levels based on the test mode. In some examples, the memory system 110 may receive, from the host system 105, a write command to write the second data, and may receive the second data via the interface 117 and write the second data to one or more memory arrays based on the write command and transferring the second data via the data path 116.

By converting from the first quantity of amplitude modulation levels to the second quantity, the memory system 110 may allow separate testing of the interface 117 and the data path 316. For example, transferring the data in accordance with the first quantity of amplitude modulation levels may result in transferring the data in accordance with a first data rate (e.g., for PAM3), while transferring the data in accordance with the second quantity of amplitude modulation levels after the conversion may result in transferring the data via the interface 117 in accordance with a second data rate that is less than the first data rate (e.g., as the second quantity may be less than the first quantity). This may lower a speed of the interface 117 to allow testing of the data path 316 at higher data rates without causing the interface 117 to fail. For example, the test mode may support testing of the data path at one or more data rates that may not be supported by the interface, or vice versa. The memory system 110 may also perform an inverse conversion, or a conversion between any two (or more) modulation schemes. For example, the FIFO circuit 310 may receive and output NRZ encoded data, where the converters 320 may convert the NRZ encoded data to PAM3 encoded data for transmission via the interface 117, which may allow testing of the interface 117 at higher data rates than the data path 316. Further, lowering a data rate at the interface 117 may increase an accuracy in strobing due to a resulting increase in a data eye height.

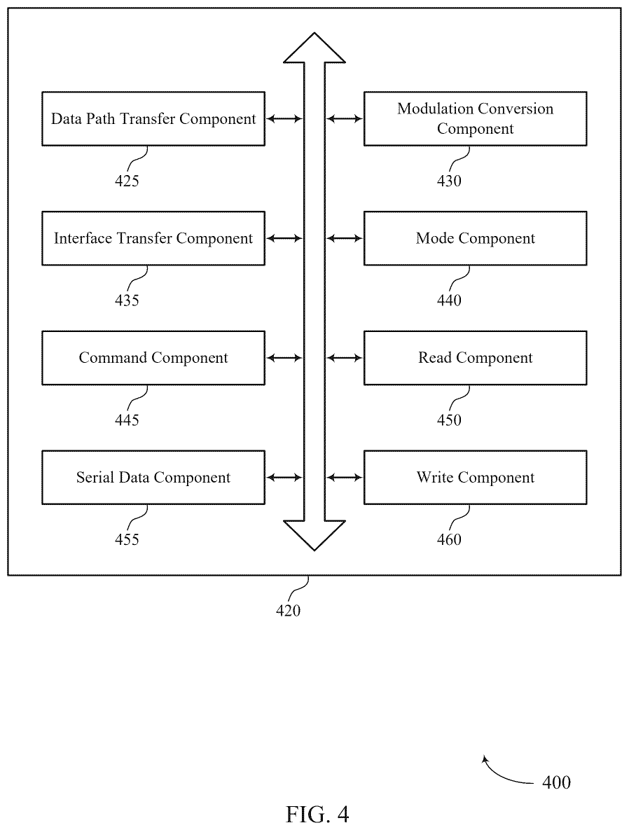

FIG. 4 shows a block diagram 400 of a memory system 420 that supports serializing data using hybrid transmission modes within a memory system in accordance with examples as disclosed herein. The memory system 420 may be an example of aspects of a memory system as described with reference to FIGS. 1 through 3. The memory system 420, or various components thereof, may be an example of means for performing various aspects of serializing data using hybrid transmission modes within a memory system as described herein. For example, the memory system 420 may include a data path transfer component 425, a modulation conversion component 430, an interface transfer component 435, a mode component 440, a command component 445, a read component 450, a serial data component 455, a write component 460, or any combination thereof. Each of these components, or components of subcomponents thereof (e.g., one or more processors, one or more memories), may communicate, directly or indirectly, with one another (e.g., via one or more buses).

The data path transfer component 425 may be configured as or otherwise support a means for transferring, from a memory array and via a data path of a memory system, data in accordance with a first quantity of amplitude modulation levels. The modulation conversion component 430 may be configured as or otherwise support a means for converting, based at least in part on a test mode for the memory system, the data from the first quantity of amplitude modulation levels to a second quantity of amplitude modulation levels that is less than the first quantity of amplitude modulation levels, where the test mode is associated with a test of the data path, a test of an interface, or both at one or more data rates. The interface transfer component 435 may be configured as or otherwise support a means for transmitting, via the interface, the data in accordance with the second quantity of amplitude modulation levels based at least in part on the test mode.

In some examples, the mode component 440 may be configured as or otherwise support a means for receiving an indication of the test mode for the memory system, where converting the data to the second quantity of amplitude modulation levels is based at least in part on the indication of the test mode.

In some examples, the mode component 440 may be configured as or otherwise support a means for receiving an indication of a second mode for the memory system. In some examples, the data path transfer component 425 may be configured as or otherwise support a means for transferring, from the memory array and via the data path, a second data in accordance with the first quantity of amplitude modulation levels based at least in part on the second mode. In some examples, the interface transfer component 435 may be configured as or otherwise support a means for transmitting the second data via the interface in accordance with the first quantity of amplitude modulation levels based at least in part on the second mode.

In some examples, the interface transfer component 435 may be configured as or otherwise support a means for receiving, via the interface, a second data in accordance with the second quantity of amplitude modulation levels based at least in part on the test mode. In some examples, the modulation conversion component 430 may be configured as or otherwise support a means for converting, based at least in part on the test mode, the second data from the second quantity of amplitude modulation levels to the first quantity of amplitude modulation levels. In some examples, the data path transfer component 425 may be configured as or otherwise support a means for transferring, to the memory array and via the data path, the second data in accordance with the first quantity of amplitude modulation levels.

In some examples, the command component 445 may be configured as or otherwise support a means for receiving, from a host device, a write command to write the second data, where receiving the second data via the interface is based at least in part on the write command. In some examples, the write component 460 may be configured as or otherwise support a means for writing the second data to the memory array based at least in part on the write command and transferring the second data via the data path.

In some examples, the command component 445 may be configured as or otherwise support a means for receiving, from a host device, a read command to read the data. In some examples, the read component 450 may be configured as or otherwise support a means for reading the data from the memory array based at least in part on the read command, where the data is transmitted to the host device based at least in part on the read command.

In some examples, the serial data component 455 may be configured as or otherwise support a means for serializing the data based at least in part on converting the data to the second quantity of amplitude modulation levels, where the data is transferred as parallel streams of data via the data path, and where the data is transmitted as a serial stream of data via the interface based at least in part on serializing the data.

In some examples, the data is transferred via the data path in accordance with a first data rate. In some examples, the data is transferred via the interface in accordance with a second data rate that is less than the first data rate based at least in part on the second quantity of amplitude modulation levels being less than the first quantity of amplitude modulation levels.

In some examples, the data is transferred via the data path in a first time period. In some examples, the data is transferred via the interface in a second time period that is longer than the first time period based at least in part on the second quantity of amplitude modulation levels being less than the first quantity of amplitude modulation levels.

In some examples, the first quantity of amplitude modulation levels includes at least three amplitude modulation levels. In some examples, the second quantity of amplitude modulation levels includes two amplitude modulation levels.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

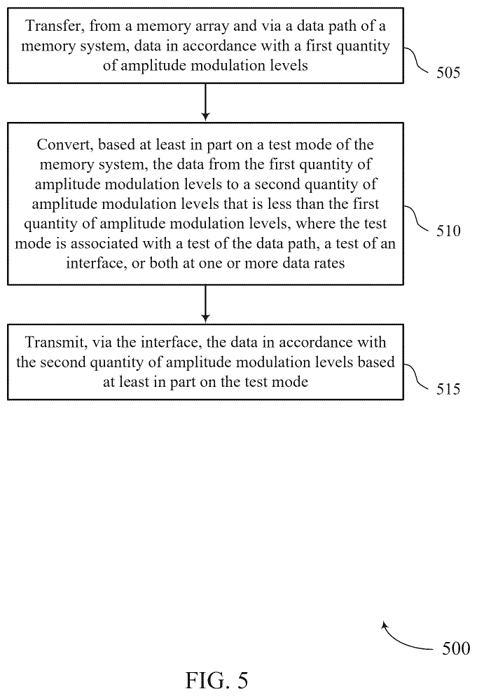

FIG. 5 shows a flowchart illustrating a method 500 that supports serializing data using hybrid transmission modes within a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include transferring, from a memory array and via a data path of a memory system, data in accordance with a first quantity of amplitude modulation levels. In some examples, aspects of the operations of 505 may be performed by a data path transfer component 425 as described with reference to FIG. 4.

At 510, the method may include converting, based at least in part on a test mode for the memory system, the data from the first quantity of amplitude modulation levels to a second quantity of amplitude modulation levels that is less than the first quantity of amplitude modulation levels, where the test mode is associated with a test of the data path, a test of an interface, or both at one or more data rates. In some examples, aspects of the operations of 510 may be performed by a modulation conversion component 430 as described with reference to FIG. 4.

At 515, the method may include transmitting, via the interface, the data in accordance with the second quantity of amplitude modulation levels based at least in part on the test mode. In some examples, aspects of the operations of 515 may be performed by an interface transfer component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for transferring, from a memory array and via a data path of a memory system, data in accordance with a first quantity of amplitude modulation levels; converting, based at least in part on a test mode for the memory system, the data from the first quantity of amplitude modulation levels to a second quantity of amplitude modulation levels that is less than the first quantity of amplitude modulation levels, where the test mode is associated with a test of the data path, a test of an interface, or both at one or more data rates; and transmitting, via the interface, the data in accordance with the second quantity of amplitude modulation levels based at least in part on the test mode.
Aspect 2: The method, apparatus, or non-transitory computer-readable medium of aspect 1, further including operations, features, circuitry, logic, means, or instructions, or any combination thereof for receiving an indication of the test mode for the memory system, where converting the data to the second quantity of amplitude modulation levels is based at least in part on the indication of the test mode.
Aspect 3: The method, apparatus, or non-transitory computer-readable medium of any of aspects 1 through 2, further including operations, features, circuitry, logic, means, or instructions, or any combination thereof for receiving an indication of a second mode for the memory system; transferring, from the memory array and via the data path, a second data in accordance with the first quantity of amplitude modulation levels based at least in part on the second mode; and transmitting the second data via the interface in accordance with the first quantity of amplitude modulation levels based at least in part on the second mode.
Aspect 4: The method, apparatus, or non-transitory computer-readable medium of any of aspects 1 through 3, further including operations, features, circuitry, logic, means, or instructions, or any combination thereof for receiving, via the interface, a second data in accordance with the second quantity of amplitude modulation levels based at least in part on the test mode; converting, based at least in part on the test mode, the second data from the second quantity of amplitude modulation levels to the first quantity of amplitude modulation levels; and transferring, to the memory array and via the data path, the second data in accordance with the first quantity of amplitude modulation levels.
Aspect 5: The method, apparatus, or non-transitory computer-readable medium of aspect 4, further including operations, features, circuitry, logic, means, or instructions, or any combination thereof for receiving, from a host device, a write command to write the second data, where receiving the second data via the interface is based at least in part on the write command and writing the second data to the memory array based at least in part on the write command and transferring the second data via the data path.
Aspect 6: The method, apparatus, or non-transitory computer-readable medium of any of aspects 1 through 5, further including operations, features, circuitry, logic, means, or instructions, or any combination thereof for receiving, from a host device, a read command to read the data and reading the data from the memory array based at least in part on the read command, where the data is transmitted to the host device based at least in part on the read command.
Aspect 7: The method, apparatus, or non-transitory computer-readable medium of any of aspects 1 through 6, further including operations, features, circuitry, logic, means, or instructions, or any combination thereof for serializing the data based at least in part on converting the data to the second quantity of amplitude modulation levels, where the data is transferred as parallel streams of data via the data path, and where the data is transmitted as a serial stream of data via the interface based at least in part on serializing the data.
Aspect 8: The method, apparatus, or non-transitory computer-readable medium of any of aspects 1 through 7, where the data is transferred via the data path in accordance with a first data rate and the data is transferred via the interface in accordance with a second data rate that is less than the first data rate based at least in part on the second quantity of amplitude modulation levels being less than the first quantity of amplitude modulation levels.
Aspect 9: The method, apparatus, or non-transitory computer-readable medium of any of aspects 1 through 8, where the data is transferred via the data path in a first time period and the data is transferred via the interface in a second time period that is longer than the first time period based at least in part on the second quantity of amplitude modulation levels being less than the first quantity of amplitude modulation levels.
Aspect 10: The method, apparatus, or non-transitory computer-readable medium of any of aspects 1 through 9, where the first quantity of amplitude modulation levels includes at least three amplitude modulation levels and the second quantity of amplitude modulation levels includes two amplitude modulation levels.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 11: A memory system, including: one or more data paths configured to convey a data in accordance with a first quantity of amplitude modulation levels; conversion circuitry configured to convert, based at least in part on a test mode for the memory system, the first quantity of amplitude modulation levels for the data to a second quantity of amplitude modulation levels that is less than the first quantity; and an interface coupled with the conversion circuitry and configured to convey the data in accordance with the second quantity of amplitude modulation levels based at least in part on the test mode for the memory system.
Aspect 12: The memory system of aspect 11, further including: serializer circuitry coupled with the conversion circuitry and the interface, the serializer circuitry configured to serialize the data for transmission via the interface, where: the data is transmitted via at least two data paths of the one or more data paths in parallel; and the data is transmitted serially via the interface based at least in part on the serializer circuitry.
Aspect 13: The memory system of any of aspects 11 through 12, further including: a pin configured to receive signaling that indicates whether the test mode is enabled for the memory system, where the pin is coupled with the conversion circuitry.
Aspect 14: The memory system of any of aspects 11 through 13, where the conversion circuitry includes one or more converters configured to convert the first quantity of amplitude modulation levels to the second quantity of amplitude modulation levels, each converter coupled with a respective data path from among the one or more data paths.
Aspect 15: The memory system of any of aspects 11 through 14, where: the first quantity of amplitude modulation levels includes at least three amplitude modulation levels; and the second quantity of amplitude modulation levels includes two amplitude modulation levels.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
processing circuitry associated with one or more memory devices and configured to cause the apparatus to:
transfer, from a memory array and via a data path of a memory system, data in accordance with a first quantity of amplitude modulation levels;
convert, based at least in part on a test mode for the memory system, the data from the first quantity of amplitude modulation levels to a second quantity of amplitude modulation levels that is less than the first quantity of amplitude modulation levels, wherein the test mode is associated with a test of the data path, a test of an interface, or both at one or more data rates; and
transmit, via the interface, the data in accordance with the second quantity of amplitude modulation levels based at least in part on the test mode.

2. The apparatus of claim 1, wherein the processing circuitry is further configured to cause the apparatus to:
receive an indication of the test mode for the memory system, wherein converting the data to the second quantity of amplitude modulation levels is based at least in part on the indication of the test mode.

3. The apparatus of claim 1, wherein the processing circuitry is further configured to cause the apparatus to:
receive an indication of a second mode for the memory system;
transfer, from the memory array and via the data path, a second data in accordance with the first quantity of amplitude modulation levels based at least in part on the second mode; and
transmit the second data via the interface in accordance with the first quantity of amplitude modulation levels based at least in part on the second mode.

4. The apparatus of claim 1, wherein the processing circuitry is further configured to cause the apparatus to:
receive, via the interface, a second data in accordance with the second quantity of amplitude modulation levels based at least in part on the test mode;
convert, based at least in part on the test mode, the second data from the second quantity of amplitude modulation levels to the first quantity of amplitude modulation levels; and
transfer, to the memory array and via the data path, the second data in accordance with the first quantity of amplitude modulation levels.

5. The apparatus of claim 4, wherein the processing circuitry is further configured to cause the apparatus to:
receive, from a host device, a write command to write the second data, wherein receiving the second data via the interface is based at least in part on the write command; and
write the second data to the memory array based at least in part on the write command and transferring the second data via the data path.

6. The apparatus of claim 1, wherein the processing circuitry is further configured to cause the apparatus to:
receive, from a host device, a read command to read the data; and
read the data from the memory array based at least in part on the read command, wherein the data is transmitted to the host device based at least in part on the read command.

7. The apparatus of claim 1, wherein the processing circuitry is further configured to cause the apparatus to:
serialize the data based at least in part on converting the data to the second quantity of amplitude modulation levels, wherein the data is transferred as parallel streams of data via the data path, and wherein the data is transmitted as a serial stream of data via the interface based at least in part on serializing the data.

8. The apparatus of claim 1, wherein:
the data is transferred via the data path in accordance with a first data rate, and
the data is transferred via the interface in accordance with a second data rate that is less than the first data rate based at least in part on the second quantity of amplitude modulation levels being less than the first quantity of amplitude modulation levels.

9. The apparatus of claim 1, wherein:
the data is transferred via the data path in a first time period, and
the data is transferred via the interface in a second time period that is longer than the first time period based at least in part on the second quantity of amplitude modulation levels being less than the first quantity of amplitude modulation levels.

10. The apparatus of claim 1, wherein:
the first quantity of amplitude modulation levels comprises at least three amplitude modulation levels, and
the second quantity of amplitude modulation levels comprises two amplitude modulation levels.

11. A memory system, comprising:
one or more data paths configured to convey a data in accordance with a first quantity of amplitude modulation levels;
conversion circuitry configured to convert, based at least in part on a test mode for the memory system, the first quantity of amplitude modulation levels for the data to a second quantity of amplitude modulation levels that is less than the first quantity; and
an interface coupled with the conversion circuitry and configured to convey the data in accordance with the second quantity of amplitude modulation levels based at least in part on the test mode for the memory system.

12. The memory system of claim 11, further comprising:
serializer circuitry coupled with the conversion circuitry and the interface, the serializer circuitry configured to serialize the data for transmission via the interface, wherein:
the data is transmitted via at least two data paths of the one or more data paths in parallel; and
the data is transmitted serially via the interface based at least in part on the serializer circuitry.

13. The memory system of claim 11, further comprising:
a pin configured to receive signaling that indicates whether the test mode is enabled for the memory system, wherein the pin is coupled with the conversion circuitry.

14. The memory system of claim 11, wherein the conversion circuitry comprises one or more converters configured to convert the first quantity of amplitude modulation levels to the second quantity of amplitude modulation levels, each converter coupled with a respective data path from among the one or more data paths.

15. The memory system of claim 11, wherein:
the first quantity of amplitude modulation levels comprises at least three amplitude modulation levels; and
the second quantity of amplitude modulation levels comprises two amplitude modulation levels.

16. A method, comprising:
transferring, from a memory array and via a data path of a memory system, data in accordance with a first quantity of amplitude modulation levels;
converting, based at least in part on a test mode for the memory system, the data from the first quantity of amplitude modulation levels to a second quantity of amplitude modulation levels that is less than the first quantity of amplitude modulation levels, wherein the test mode is associated with a test of the data path, a test of an interface, or both at one or more data rates; and
transmitting, via the interface, the data in accordance with the second quantity of amplitude modulation levels based at least in part on the test mode.

17. The method of claim 16, further comprising:
receiving an indication of the test mode for the memory system, wherein converting the data to the second quantity of amplitude modulation levels is based at least in part on the indication of the test mode.

18. The method of claim 16, further comprising:
receiving an indication of a second mode for the memory system;
transferring, from the memory array and via the data path, a second data in accordance with the first quantity of amplitude modulation levels based at least in part on the second mode; and
transmitting the second data via the interface in accordance with the first quantity of amplitude modulation levels based at least in part on the second mode.

19. The method of claim 16, further comprising:
receiving, via the interface, a second data in accordance with the second quantity of amplitude modulation levels based at least in part on the test mode;
converting, based at least in part on the test mode, the second data from the second quantity of amplitude modulation levels to the first quantity of amplitude modulation levels; and
transferring, to the memory array and via the data path, the second data in accordance with the first quantity of amplitude modulation levels.

20. The method of claim 19, further comprising:
receiving, from a host device, a write command to write the second data, wherein receiving the second data via the interface is based at least in part on the write command; and
writing the second data to the memory array based at least in part on the write command and transferring the second data via the data path.

21. The method of claim 16, further comprising:
receiving, from a host device, a read command to read the data; and
reading the data from the memory array based at least in part on the read command, wherein the data is transmitted to the host device based at least in part on the read command.

22. The method of claim 16, further comprising:
serializing the data based at least in part on converting the data to the second quantity of amplitude modulation levels, wherein the data is transferred as parallel streams of data via the data path, and wherein the data is transmitted as a serial stream of data via the interface based at least in part on serializing the data.
